(19) United States
(12) Patent Application Publication
(10) Pub. No.: US 2010/0242014 A1
(43) Pub. Date: Sep. 23, 2010

(54) SYMMETRIC MULTI-PROCESSOR OPERATING SYSTEM FOR ASYMMETRIC MULTI-PROCESSOR ARCHITECTURE

(76) Inventor: Xiaohan Zhu, Alviso, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/405,555

(22) Filed: Mar. 17, 2009

(51) Int. Cl. G06F 9/46; G06F 9/06; G06F 9/44

(52) U.S. Cl. 717/106; 712/220; 718/102; 712/E09.003; 717/162

(57) ABSTRACT

A method and system for supporting multi-processing within an asymmetric processor architecture in which processors support different processor specific functionality. Instruction sets within processors having different functionalities are modified so that a portion of the functionality of these processors overlaps within a common set of instructions. Code generation for the multi-processor system (e.g., compiler, assembler, and/or linker) is performed in a manner to allow the binary code to be generated for execution on these diverse processors, and the execution of generic tasks, using the shared instructions, on any of the processors within the multiple processors. Processor specific tasks are only executed by the processors having the associated processor specific functionality. Source code directives are exemplified for aiding the compiler or assembler in properly creating binary code for the diverse processors. The invention can reduce processor computation requirements, reduce software latency, and increase system responsiveness.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to microprocessor devices and computing, and more particularly to multi-processing on an asymmetric architecture.

2. Description of Related Art

In traditional multi-processor operating systems, all the processors in the system are exactly the same. The operating system can assign a task or a process to any of the processors within the computer system. Computer architectures and operating systems of this kind are referred to as symmetric multi-processor (SMP) systems.

However, in the marketplace today microprocessors are ubiquitous and found in various forms doing various functions at various levels in the hierarchy, within a system or even within a single embedded system. It will be noted that in these diverse multi-level computing environments each of the microprocessor is optimized for different purposes to achieve the best performance and power requirement. As an example, in a SOC (System on Chip) for portable media players, one processor is perhaps optimized for performing digital signal processing (e.g., as a DSP) for video decoding, while another processor is directed at running applications and decoding audio. An architecture of this form is referred to as an asymmetric multi-processor (AMP) or (ASP) architecture.

It should be appreciated that in an AMP system, each processor may have completely different instruction sets and memory configurations. For example, one processor may have SIMD (Single instruction multiple data) instructions, while other processors may only provide standard RISC instructions. Some processors may have specialized local memory and DMA engines attached. As a consequence of these many differences, it is not surprising that different compilers, assemblers and linkers can be required for generating the code for each of the processors. While it is well understood that the generated binary code may only be loaded onto the designated processor.

Accordingly, it is not possible for current operating systems, such as SMP based operating systems (e.g., Linux) to take advantage of the multi-processor computing power which is available on diverse computational systems. In an SMP system, all the processors have exactly the same instruction set and they share a unified memory view. In most configurations, there are caches attached to each processor. The system normally ensures cache coherency among the caches, so that when one processor modified the contents of an address, all other processors in the system immediately see the same changes. This cache coherency scheme is often accomplished by a Snoop protocol. The Snoop protocol is a TCP-aware link layer protocol designed to improve the performance of TCP over networks of wired and single-hop wireless links.

By way of example, in systems such as video cameras the most computational intensive process is that of video analysis and processing, in particular if the original video is in high definition. A high performance processor is required, for instance, to first decode the original video sequence and then analyze each video and audio frame. In an embedded device like a camcorder, video and audio are normally encoded by specialized hardware, while the generic computing power for the microprocessor on the device can be very limited. Thus, the camcorders represent many device which require processors tailored for specific forms of processing, whereby conventional SMP multiprocessing approaches are not applicable.

Accordingly a need exists for a system and method of performing a form of multiprocessing utilizing the processing resources found within an asymmetric processing environment. These needs and others are met within the present invention, which overcomes the deficiencies of previously developed multiprocessing systems and methods.

### BRIEF SUMMARY OF THE INVENTION

The present invention is directed at optimizing the use of processing resources within an AMP architecture. Toward this end the ability is provided for assigning tasks to the underlying AMP processing elements as in an SMP operating system, yet while retaining the ability to run programs optimized for asymmetric processors within the system. Thus, processing power within the AMP environment can be cast according to the invention into an SMP architecture which takes advantage of the processor computing power of the asymmetric processing elements. The present invention in essence creates a symmetric multi-processor operating system, or environment, for an asymmetric multi-processor architecture which contains processors having processor specific functionality.

In order to create this SMP environment over an AMP framework, both the typical hardware and software of the AMP environment must be modified. Instructions sets within processors having different functionalities are modified so that a portion of the functionality of these processors overlaps within a common set of instructions. The invention also teaches compiler, assembler, and linker modifications which allow the binary code to be generated for execution on these diverse processors, and the execution of generic tasks, using the shared instructions, on any of the processors within the multiple processors. It will be noted, however, that the code loaded on one or more of these processors can be changed, such as in response to different operating modes. The code generated for generic functions can be equivalent on different processors, while code containing function specific instructions can be based on similar generic functions therein allowing respectively for maximum reusability and minimum development effort.

It should be appreciated that the present invention can reduce processor requirements, because the processing load is shared across a diverse set of processors. In addition, software latency can be reduced as tasks are performed on processors having fewer active tasks. The invention is particularly well suited for use in SOC based embedded systems, such as for example associated with video and audio systems.

The invention is amenable to being embodied in a number of ways, including but not limited to the following descriptions.

One embodiment of the invention is an apparatus for asymmetric multi-processing, comprising: (a) a plurality of processors configured for executing instructions in response to tasks scheduled for execution within the plurality of processors; (b) a communication pathway interconnecting processors within the plurality of processors, wherein each of the processors in the plurality of processors is configured for executing an instruction set which includes a set of common instructions which are common to all processors in the plurality of processors; (c) one or more of the processors is configured with processor specific instructions for controlling processor specific functions which can not be executed by the other processors within the plurality of processors wherein the multi-processor apparatus is asymmetric; and (d) a task scheduler configured for assigning tasks containing only common instructions to any of the plurality of processors, while tasks containing processor specific functions are assigned to one or more specific processors configured for executing those specific functions. Any processor specific functions can be supported within the apparatus, including digital signal processing, stream processing, video processing, audio processing, digital control, acceleration processing, single-instruction multiple-data processing (SIMD) and combinations thereof. In one implementation of the invention the processors within the AMP system are embodied in an SOC device.

In the above apparatus the instructions for execution by the plurality of processors are generated by a compiler or assembler, which is configured for generating binary code for each processor with common instructions generated for each processor, and including processor specific instructions generated within the binary code for processors configured for performing the associated processor specific functions. It will be noted that conventional multi-processing is restricted to operation on symmetric architectures where each processor has the same instruction set, and the compiler/assembler need not modulate its binary code generation for the system in response to the different functionality of each processor and their multi-processing interrelationship. The task scheduler for the apparatus is preferably executed in response to programming executing on at least one of the plurality of processors, such as within an operating system.

One embodiment of the invention is an apparatus for generating binary code in response to compiling or assembling source code for execution within an asymmetric multi-processing system, comprising: (a) receiving source code containing a plurality of functions for execution by processors within an asymmetric multi-processing system; (b) mapping functions from within said source code to indicate which system functions are generic and thus contain common instructions for all processors in the asymmetric multi-processing system, and which functions contain instructions directed to one or more specific processors capable of executing the processor specific instructions; (c) outputting binary code containing common instructions for each processor in said asymmetric multi-processing system, and a combination of common instructions and processor specific instructions for processors within the asymmetric multi-processing system which support processor specific functions. In response to this compilation/assembly the binary code generated for common instructions is configured for execution by at least one task executing on any of the processors within the asymmetric multi-processing system, and the binary code which is generated contains processor specific instructions configured for execution by at least one task configured for execution on one or more of the processors within the asymmetric multi-processing system which supports the processor specific functions.

The binary code (programming) generated by the apparatus is configured for execution, such as by tasks scheduled by an operating system that determines which tasks should be assigned to which processors in response to function mapping for the specific plurality of processors in the target system. It will be appreciated that directives are decoded from within the source code to tell the compiler/assembler which functions are directed to which specific processors, or alternatively to all processors. In one mode of the invention, a header and footer designate the portion of source code whose associated binary code is to be generated for one or more specific processors. In another mode, a macro designates the portion of source code whose associated binary code is to be generated for one or more specific processors. In another example mode, text within a function definition designates whether the function is directed to any of the processors, or to one or more specific processors. In addition to the compiler/assembler, a linker is preferably adapted for assigning absolute addresses to functions for each of the processors within the asymmetric multi-processing system. It should be appreciated that the apparatus can support any desired processor specific instructions, including but not limited to, digital signal processing, stream processing, video processing, audio processing, digital control, acceleration processing, single-instruction multiple-data processing and combinations thereof.

It should be appreciated that the processors within the asymmetric multi-processing system have an instruction set adapted so as to have a portion of the instruction set for each processor being shared in common, as common instructions, with other processors to be used within the asymmetric multi-processing system. Yet, one or more of the processors have processor specific instructions which extend beyond the common instructions that cannot be executed on all the other processors in the asymmetric multi-processing system. The binary code generated by the apparatus is configured so that tasks using the task generic functions can be executed on any of the processors within the asymmetric multi-processing system, while tasks using processor specific functions can be executed only by one or more specific processors which are capable of executing those processor specific functions.

One embodiment of the invention is a method of controlling execution of general (e.g., generic, common, shared), and processor-specific tasks within an asymmetric multi-processing system having multiple interconnected processors capable of performing different functionality, comprising: (a) adapting the instruction set of each processing element within a multi-processing system so that a portion of the instruction set for each processor is shared in common, as common instructions, while one or more of the processors include processor specific instructions, associated with processor specific functions, which cannot be executed on all the other processors in the asymmetric multi-processing system; (b) generating binary code for execution on each of the processors within the asymmetric multi-processing system by, (b)(i) outputting binary code of the common instructions for each of the processors within the asymmetric multi-processing system, (b)(ii) creating a function map indicating which system functions are generic and which functions are directed to one or more specific processors capable of executing processor specific instructions, and (b)(iii) outputting binary code of the processor specific instructions for one or more of the processors which include processor specific instructions.

The method can be configured with a linker which is adapted to assign absolute addresses to functions for each of the processors within said asymmetric multi-processing system. In one implementation of the invention one or more of the processors is configured for executing a task scheduler that assigns generic tasks, those containing only common instructions, to any of the plurality of processors, while tasks containing processor specific functions are assigned to one or more specific processors configured for executing those specific functions. The method can support any desired core of common processing functionality (and their respective instructions) and any desired processor specific functions (and respective instructions extending the core) including functions such as digital signal processing, stream processing, video processing, audio processing, digital control processing, hardware acceleration processing, single-instruction multiple-data processing and combinations thereof.

The present invention provides a number of beneficial aspects which can be implemented either separately or in any desired combination without departing from the present teachings.

An aspect of the invention is to provide SMP processing functionality within an AMP architecture.

Another aspect of the invention is to allow performing tasks within the AMP architecture on any processor having suitable processor functionality.

Another aspect of the invention is a method of modifying diverse processor instruction sets to overlap within a common instruction set, wherein generic tasks can be executed on any of the processors within the system.

Another aspect of the invention is a method of extending the common instruction set to support specific functions on one or more processors within the target asymmetric multi-processing system.

Another aspect of the invention is to provide a compiler or assembler which is adapted for generating binary code, while taking into account the common instructions and respecting the processor specific functions.

Another aspect of the invention is a system which can utilize available processor bandwidth from one processor to perform generic system tasks or tasks for another processor.

A still further aspect of the invention is a method of reducing the computing power of processing elements and their requisite cost.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of hardware within an asymmetric multi-processing core according to an aspect of the present invention.

FIG. 2 is a block diagram of general purpose tasks and processor specific tasks configured for being executed within an asymmetric multi-processing system according to an aspect of the present invention.

FIG. 3 is a task-data flow diagram of generic tasks and processor specific tasks being scheduled on different processor cores according to an aspect of the present invention.

FIG. 4-6 are pseudo-source code listings showing examples of designating which processor or processors a given section of code, or function, are directed to according to an aspect of the present invention.

FIG. 7 is a flowchart of generating binary code through compilation and linking processes according to an aspect of the present invention.

FIG. 8 is a timing diagram of task processing within an example asymmetric multi-processing system containing four processors according to an aspect of the present invention.

### DETAILED DESCRIPTION OF THE INVENTION

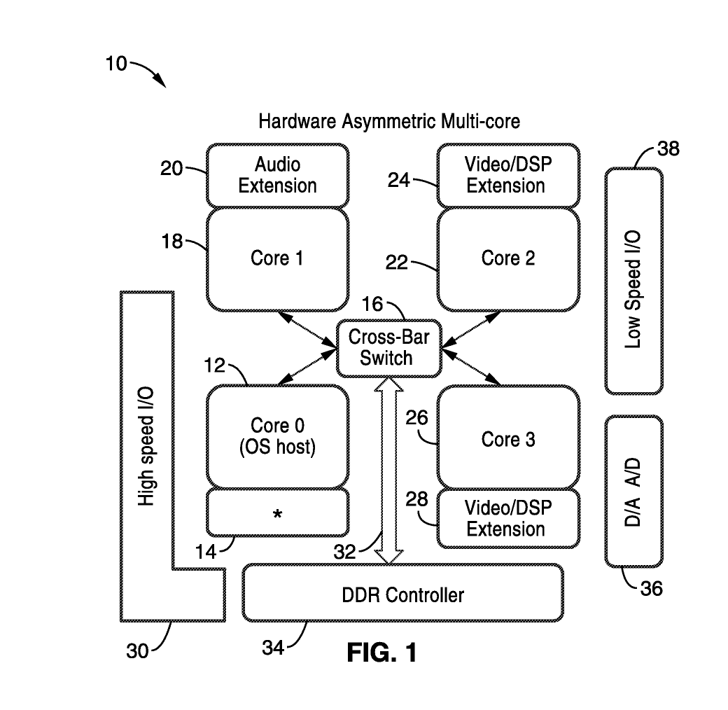

Referring more specifically to the drawings, for illustrative purposes the present invention is embodied in the apparatus generally shown in FIG. 1 through FIG. 8. It will be appreciated that the apparatus may vary as to configuration and as to details of the parts, and that the method may vary as to the specific steps and sequence, without departing from the basic concepts as disclosed herein.

In order to create an SMP environment for optimizing processor utilization, the invention teaches changes to both the hardware and software for existing AMP architectures.

On the hardware side the proposed architecture modifies the AMP architecture wherein a portion of it maps an SMP architecture, without sacrificing processor specific functionality. Each processor in the system is configured so that at least a portion of processor instructions are shared within a common instruction set with associated op-codes. Accordingly, a generic software tool chain can then be configured which includes compiler, assembler and linker providing an SMP view of this architecture. It is well known that compilers, assemblers and linkers are software which execute as programming from the memory of a computer adapted for receiving source codes and generating binary code. Therefore, as the configuration of general purpose computers for running compilers, assemblers and linkers is well known it need not be discussed. In one mode of the invention, these tool chains are only aware of the common instruction op-code of the processors and therefore the generated binary code files can be executed on any of the processors in the system. On top of the common instruction op-codes, different instruction extensions are provided for specific processors.

By way of example and not limitation, some processors may have instruction extensions optimized for signal processing applications (DSP), such as video, while other processors may have instruction extensions optimized for audio or stream processing types of applications. These processors may also have local memory, or even digital control and/or acceleration processing (e.g., memory management unit, array processors and so forth), or single-instruction multiple-data (SIMD) processing that is not visible to other processors. Using the extended instruction set with these processors can require specific compilation and assembly techniques targeting each processor which is to be used. The same linker, when modified to be cognizant of the function-core mapping, can be used to link all of the sections of object code into a final executable.

Accordingly, on the software side, changes have to be made to the scheduler and loaders for the operating system. When the operating system loads an executable, it first checks if the software task is a generic task or a special optimized task. A generic task is generated by the common tool chain and thus uses common instructions for the set of processors. The generic tasks are treated as a normal process in the operating system. In one simple implementation of the present invention, the operating system uses standard context switches to schedule these tasks among all the processors in the system.

Special optimized tasks contain instruction op-codes that are optimized for one or more designated processors in the system. The scheduler of the operating system is aware that this task can only be assigned to one or more designated cores in the system. According to one implementation of the invention, these special tasks can be executed in one of two modes. In a first mode, the task can be context switched out of the target processor by a generic software task or another specialized task that is targeting the same processor. The other mode is an exclusive mode, wherein the operating system marks the processor as busy until the task explicitly exits, and wherein the scheduler would not trigger any context switches to this processor.

FIG. 1 illustrates an embodiment 10 showing the hardware and software architecture for an example of the inventive system. It should be appreciated that the figure is shown by way of example and not limitation, wherein the number of cores, types of extensions, types of switching, connection to I/O (input/output) and memory, as well as other variations can be implemented by one of ordinary skill in the art without departing from the teachings of the present invention.

Core 0 is shown in block 12 as an operating system (OS) host, also referred to as a scheduler, with an extension block 14 shown as optional (e.g., with “*”). In the configuration shown Core 0 in block 12 would largely perform scheduling in addition to duties such as user interface functions. It should be appreciated that scheduling may be performed by more than one processor and configured in a number of different ways as will be understood by one of ordinary skill in the art. Interprocessor communication (communication pathway) 16 is represented as a cross-bar switch which allows moving information and tasks between processors.

Core 1 in block 18 is shown coupled with audio extensions 20. In this example Core 1 is thus configured for handling audio processing, but has a core which can perform the generic tasks. Core 2 in block 22 is adapted with extensions 24 for processing video, such as performing digital signal processing. Core 3 in block 26 is similarly adapted with extensions 28 for processing video.

Digital input/output 30 is represented as high speed I/O. An interface to memory is depicted by way of example through a double data rate (DDR) controller 34 connected to the set of processing cores through data pipe 32 coupled through switch connection 16. It will be noted that DDR controllers are known in the art, such as for providing double speed access and control in relation to synchronous dynamic random access memories. One of ordinary skill in the art will appreciate that different forms of memory and memory interfacing can be utilized without departing from the teachings of the present invention. Interfacing with analog I/O is shown in block 36 representing analog-to-digital (A/D) conversion as well as digital-to-analog (D/A) conversion, therein allowing analog signals to be measured and/or generated. It will be appreciated that different applications will have different levels of need for analog functionality, and that these aspects are shown merely by way of example of processor specific functionality for which processor specific instructions are included in the instruction set. Block 38 depicts the connection of low speed digital I/O, for example that which is directed from or to a user does not require rapid updates, and can in many instances be performed within a background task, or other “as-time-permits” processing (e.g., lowest priority task, polling loops, and so forth).

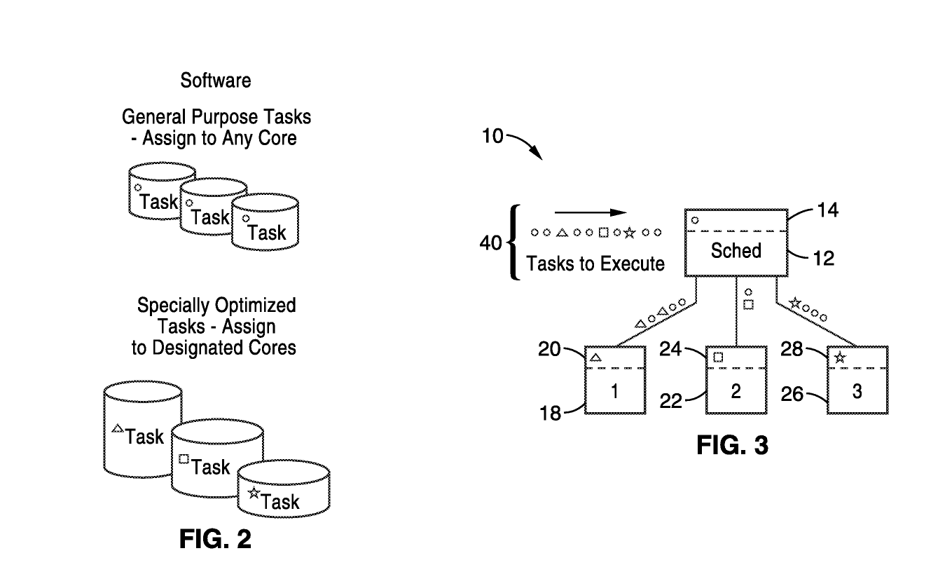

FIG. 2 illustrates that different generic and processor specific types of tasks can be executed on the asymmetric (AMP) system. By way of example, the tasks shown in the upper portion of the figure are represented with a circle as a task type designation for a generic task (associated with generic or common, instructions) that can be performed on any of the processors. Although these tasks are shown with the same size and shape blocks (cylinders), it should be appreciated that the amount, form, and complexity of the task can vary as desired. The tasks shown in the lower portion of the figure are specially optimized tasks configured for being directed to processors having specific computational resources. To represent these resources and the different types of computation being performed, these cylindrical blocks are shown in different sizes and shown with geometric indicia (e.g., triangle, square, and star). One of ordinary skill in the art will appreciate that the indicia and shape of the blocks is only used as a means of describing task difference.

FIG. 3 illustrates one mode of scheduling according to the present invention in regards to the architecture shown in FIG. 1. The tasks which need to be processed are shown containing generic tasks, represented here as circles, in addition to three different set of specific tasks, represented herein with triangles, squares, and stars. A scheduler block 12, 14, as shown here can itself process generic tasks (circles) while scheduling out the remainder to other processors. In addition, the scheduler oversees the execution of all the function specific tasks to be performed on the function specific processors. For example processor block 18, 20 is shown receiving both generic tasks and tasks specific to its processor configuration, herein depicted as a triangle symbol. Similarly, blocks 22, 24 process generic tasks as well as specific tasks represented as squares, while blocks 26, 28 process generic tasks and specific tasks represented as stars.

Typically, the majority of applications in the operating system would run as generic tasks to take advantage of the multi-processor platform. It will be noted that typically performance critical tasks may rely on libraries or middle-ware functionality which can be optimized for operation on special processors (e.g., non-generic).

It should also be appreciated that the functions performed by each of the cores can vary in response to the application being performed. For example, if the architecture shown in FIG. 1 is operating in an internet TV mode (IPTV), such as a portable media player, then block 14 of core 0 may provide memory management functionality, while Core 3 may be put into a low-power state as not being needed. It will be noted that processors performing specific task functionality can be subject to substantially different power requirements, wherein the system, such as in response to scheduler directive, is adapted to determine whether or not to power down cores when their specific functions are not being used and sufficient processing resource exists to execute the generic tasks. In other modes, such as a camcorder mode, the cores can be adapted for use in other ways, thus again optimizing processor utilization in response to the type of activity, level of activity, power consumption and other factors.

It should be appreciated that the present invention can be implemented with different forms of task “scheduling” as well as different forms of syntax for controlling a compiler in generating the necessary binary code. An assembler configured according to the present invention can automatically determine if the code is directed to specific processors in response to detecting processor specific instructions within a given function, wherein this information can be passed into a function map. A compiler (e.g., generating binary code from high level coding, instead of from assembly coding) according to the present invention, however, does not often yield a one-to-one correspondence between source code instructions and processor instructions, wherein it is preferred that directives be included in the high level source code as to which processor should fulfill the request. In this way the compiler can readily determine which set of processor instructions to use when generating the binary code, such as for a specific function. It should be noted that processor specific functionality is not limited to instruction set, as certain processors may for example have access to select I/O or memory addresses, which may need to be accessed to fulfill specific tasks. In some instances where a specific processor is not tied to a specific I/O, such as in regard to digital accelerator functions, a compiler could actually generate binary code for either a generic processor or a specific processor using the extended instruction set. In these instances it is also important that the source code for the functions designate in some manner whether the source is to be rendered with generic instructions, or in response to one or more processor specific instruction extensions. The following teachings provide a few examples of designating to the compiler which processor core the source code is to be compiled for.

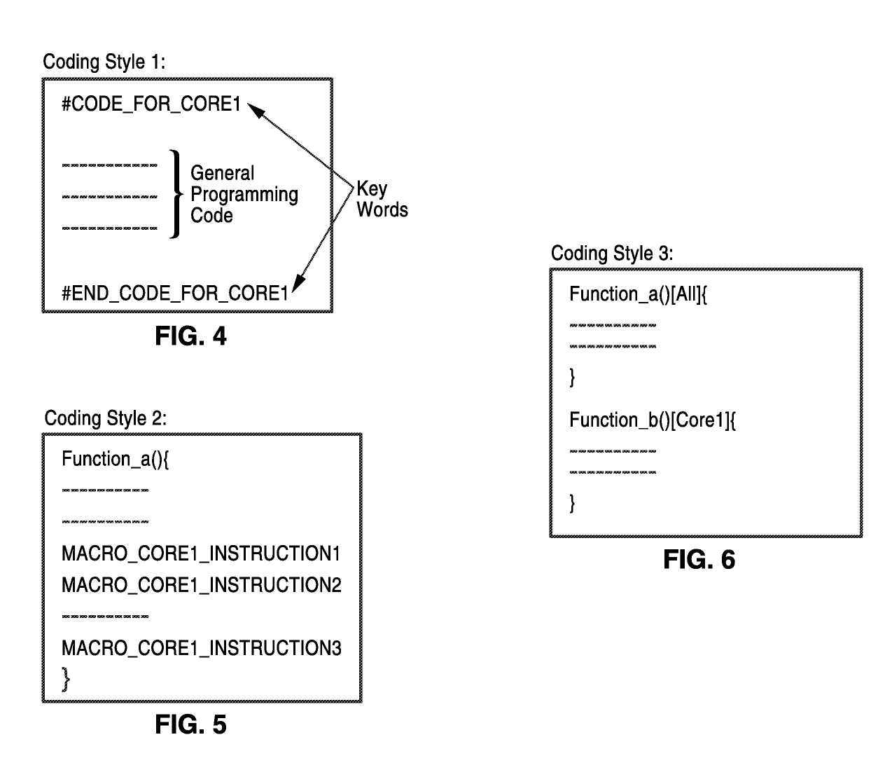

FIG. 4 through FIG. 6 illustrate example coding styles to allow the programmer to direct compilation of code executable on the processors within the system, such as exemplified by FIG. 1. FIG. 4 depicts a mechanism (e.g., syntax) for directing the compiler to direct a group of instructions toward a specific processor. In response to the delineation of header and footer, the body of instructions between the header and footer are compiled for the specific processor listed as “CORE1”. FIG. 5 illustrates a second example in which macro instructions are used, which the compiler then expands out and directs to the specific processor. In this example three sequential instructions are to be performed by “CORE1” within a set of generic commands represented as “--------” in the example. Typically, absolute addresses are assigned to the functions after linking. FIG. 6 illustrates a third alternative and/or additional mechanism which may be adopted, in which a specifier is encoded within the function definition as to whether a given function can be directed to any of the target processors, or must be directed at one or more of the specific processors within the target system.

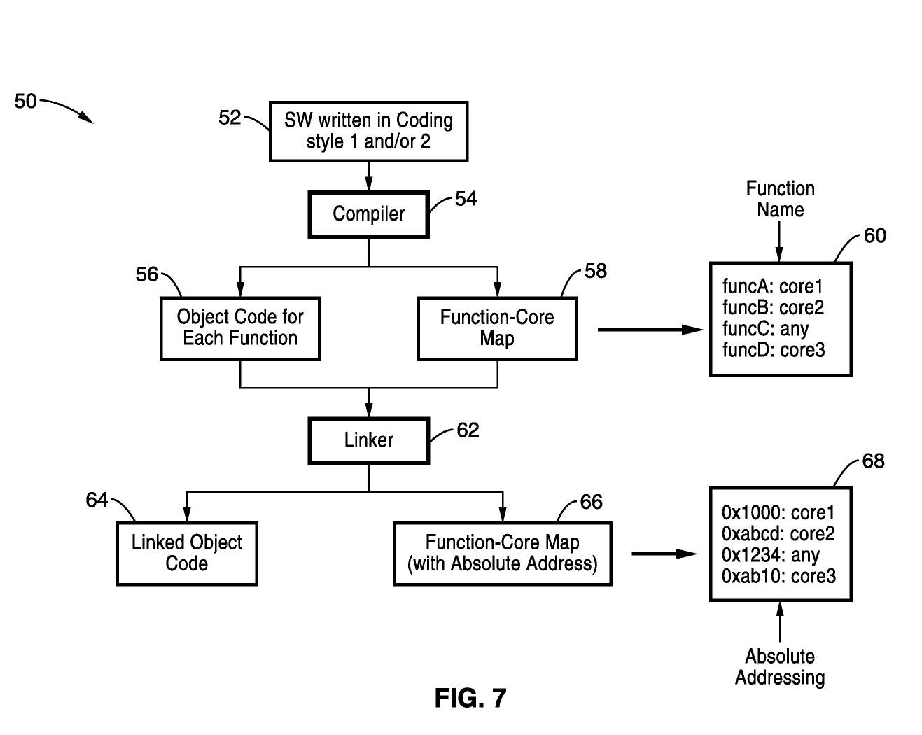

FIG. 7 illustrates an example embodiment 50 of generating code in response to functions accessed by tasks to be executed on the system as a whole. The software source code in block 52 is received as written per FIG. 4-6 into a compiler 54 which generates object code for each function 56 and provides mapping 58 of the functions for each of the cores. At this point the functions have names (non-absolute addressing) and association with specific cores, or are generic (for any cores) as shown in block 60. Compiled code is then linked 62 generating a linked object code 64 with absolute function-core mapping 66, an example shown in block 68 depicting absolute addresses for functions within the various cores.

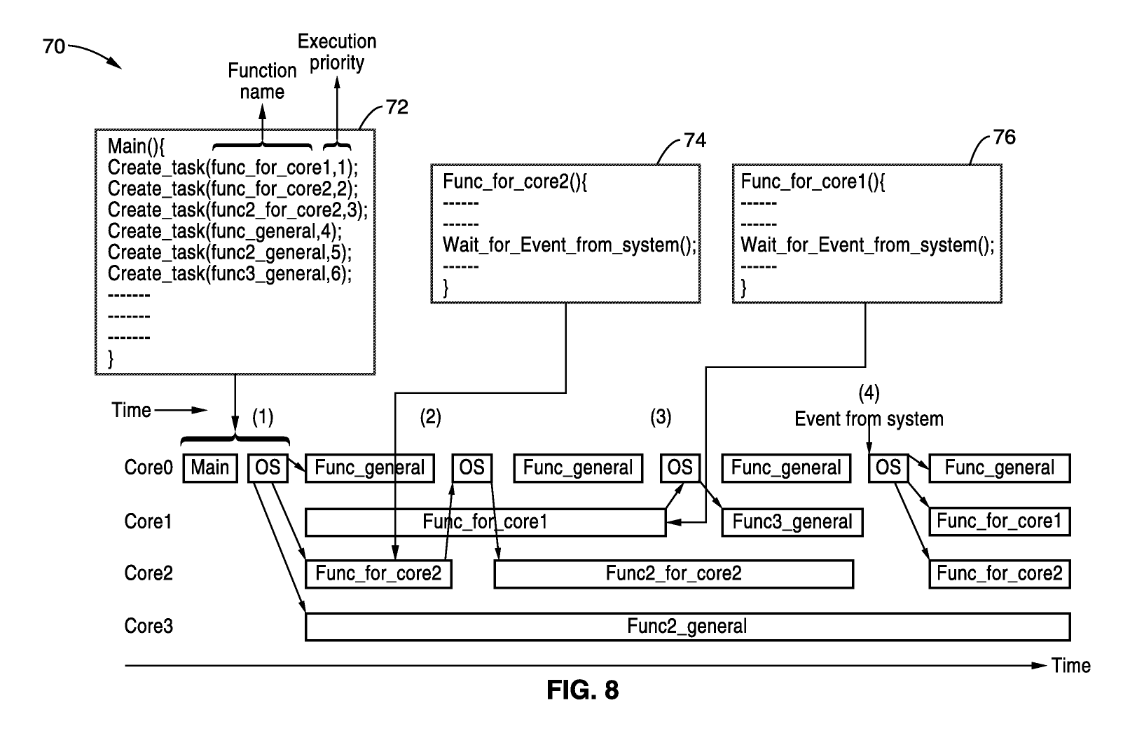

FIG. 8 illustrates an example 70 of how the scheduler in the OS assigns tasks to Cores. The diagram depicts processing for each of the cores (Core0 through Core3) with respect to time. Four general time period sections are shown to identify different portions of the function execution diagram.

In the first (1) time period the Main function 72 starts on Core0 and issues a system call to create tasks with arguments of function address and execution priority. The OS can determine which task should be assigned to which core using the function-core map as generated by the compiler and in response to execution priority. In this example case, func2_for_core2 represented in block 74, and func3_general are not executed at this point.

Moving into the second (2) time period, func_for_core2 on Core 2 issues a system call to tell the scheduler that it needs to wait for an event (e.g., “pend”) from the system and sleep until then, as seen in block 74. In response, the OS suspends func_for_core2 and assign func2_for_core2 to Core2.

Moving into the third (3) time period, the same pend status is shown arising in regard to Core1, with representative operations shown in block 76. In this case, even if func_for_core2 is ready to execute, it can go only to Core2; wherein func3_general which can be executed on any Core is assigned to Core1.

Finally, in moving through the fourth (4) time period, the OS receives an event from the system. Since func_for_core1 and func_for_core2 are waiting for the event, and func3_general and func2_for core2 have lower priority than the others.

The present invention thus teaches a method and apparatus for multi-processing on an asymmetric system. Different aspects of this invention are described including target hardware and software, tools required for generating binary code for the target, and the method of creating an SMP like environment over an AMP, asymmetric, system. It will be appreciated that the figures herein are shown by way of example toward understanding aspects of the present invention and are not intended to limit the practice of the invention. One of ordinary skill in the art will appreciate that the teachings of the present invention may practiced in various ways and with various mechanisms without departing from the present invention.

Although the description above contains many details, these should not be construed as limiting the scope of the invention but as merely providing illustrations of some of the presently preferred embodiments of this invention.

Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for asymmetric multi-processing, comprising:
a plurality of processors configured for executing instructions in response to tasks scheduled for execution within said plurality of processors;
a communication pathway interconnecting individual processors within said plurality of processors;
wherein each of said processors in said plurality of processors is configured for executing an instruction set which includes a set of common instructions which are common to all processors in said plurality of processors;
wherein one or more of said processors is configured with processor specific instructions for controlling processor specific functions which can not be executed by the other processors within said plurality of processors wherein said multi-processor apparatus is asymmetric; and
a task scheduler configured for assigning tasks containing only common instructions to any of said plurality of processors, while tasks containing processor specific functions are assigned to one or more specific processors configured for executing those specific functions.

2. An apparatus as recited in claim 1, wherein said instructions for execution by said plurality of processors are generated by a compiler or assembler, which is configured for generating binary code for each processor with common instructions generated for each processor, and including processor specific instructions generated within the binary code for processors configured for performing the associated processor specific functions.

3. An apparatus as recited in claim 1, wherein said processor specific functions are selected from the group of processing activities consisting of digital signal processing, stream processing, video processing, audio processing, digital control, acceleration processing, single-instruction multiple-data processing (SIMD), and combinations thereof.

4. An apparatus as recited in claim 1, wherein said task scheduler is executed on programming which executes on at least one of said plurality of processors.

5. An apparatus as recited in claim 1, wherein said task scheduler is executed within an operating system.

6. An apparatus for generating binary code in response to compiling or assembling source code for execution within an asymmetric multi-processing system, comprising:
a computer;
programming configured for executing from said computer for,
receiving source code containing a plurality of functions for execution by processors within an asymmetric multi-processing system,
mapping functions from within said source code to indicate which system functions are generic containing common instructions for all processors in the asymmetric multi-processing system, and which functions contain instructions directed to one or more specific processors capable of executing processor specific instructions,
outputting binary code containing common instructions for each processor in said asymmetric multi-processing system, and a combination of common instructions and processor specific instructions for processors within the asymmetric multi-processing system which support processor specific functions,
wherein said binary code generated for common instructions is configured for execution by at least one task configured for execution on any of the processors within the asymmetric multi-processing system, and said binary code generated containing processor specific instructions is configured for execution by at least one task configured for execution on one or more of the processors within the asymmetric multi-processing system which supports processor specific functions.

7. An apparatus as recited in claim 6, wherein said binary code is configured for execution directed by an operating system which determines which tasks should be assigned to which processors in response to said mapping of functions.

8. An apparatus as recited in claim 6, further comprising decoding directives contained within said source code indicating which functions are directed to a specific processor.

9. An apparatus as recited in claim 8, wherein a header and footer designate a portion of source code whose associated binary code is to be generated for one or more specific processors.

10. An apparatus as recited in claim 8, wherein a macro designates a portion of source code whose associated binary code is to be generated for one or more specific processors.

11. An apparatus as recited in claim 8, wherein text within a function definition designate whether the function is directed to any of the processors, or to one or more specific processors.

12. An apparatus as recited in claim 6, further comprising a linker adapted to assign absolute addresses to functions for each of the processors within the asymmetric multi-processing system.

13. An apparatus as recited in claim 6, wherein said processor specific instructions are selected from the group of non-generic processing activities consisting of digital signal processing, stream processing, video processing, audio processing, digital control, acceleration processing, single-instruction multiple-data processing (SIMD), and combinations thereof.

14. An apparatus as recited in claim 6:
wherein the processors within the asymmetric multi-processing system have an instruction set adapted with a portion of the instruction set for each processor being shared in common, as common instructions, with other processors to be used within the asymmetric multi-processing system; and
wherein one or more of the processors have processor specific instructions which extend beyond the common instructions that cannot be executed on all the other processors in the asymmetric multi-processing system.

15. An apparatus as recited in claim 6, wherein said binary code generated by said apparatus is configured so that tasks using generic functions can be executed by any of the processors within the asymmetric multi-processing system, while tasks using processor specific functions can be executed only by one or more specific processors which are capable of executing those processor specific functions.

16. A method of controlling execution of general and processor-specific tasks within an asymmetric multi-processing system, comprising:
adapting the instruction set of each processing element within a multi-processing system so that a portion of the instruction set for each processor is shared in common, as common instructions, while one or more of the processors includes processor specific instructions, associated with processor specific functions, which cannot be executed on all the other processors in the asymmetric multi-processing system;
generating binary code for execution on each of the processors within the asymmetric multi-processing system by,
outputting binary code of the common shared instructions for each of the processors within the asymmetric multi-processing system,
creating a function map indicating which system functions are generic and which functions are directed to one or more specific processors capable of executing processor specific instructions, and
outputting binary code of the processor specific instructions for said one or more of the processors which include processor specific instructions.

17. A method as recited in claim 16, further comprising a linker adapted to assign absolute addresses to functions for each of the processors within said asymmetric multi-processing system.

18. A method as recited in claim 16, wherein processors within the asymmetric multi-processing system are interconnected with a communication pathway.

19. A method as recited in claim 16, wherein one or more of said processors within the asymmetric multi-processing system is configured for executing a task scheduler which is configured for assigning tasks containing only common instructions to any of said plurality of processors, while tasks containing processor specific functions are assigned to one or more specific processors configured for executing those specific functions.

20. A method as recited in claim 16, wherein said processor specific functions comprise functions selected from the group of processing activities consisting of digital signal processing, stream processing, video processing, audio processing, digital control processing, hardware acceleration processing, single-instruction multiple-data processing (SIMD), and combinations thereof.
